(19) United States
(12) Patent Application Publication
(10) Pub. No.: US 2006/0153600 A1
(43) Pub. Date: Jul. 13, 2006

(54) Doctor blade within toner cartridge, material and structure thereof

(76) Inventor: Ming-Cheng Huang, Jhongli City (TW)

Correspondence Address: RABIN & Berdo, PC, 1101 14TH STREET, NW, SUITE 500, WASHINGTON, DC, 20005, US

(21) Appl. No.: 11/033,816

(22) Filed: Jan. 13, 2005

(51) Int. Cl. G03G 15/08

(52) U.S. Cl. 399/284

(57) ABSTRACT

A doctor blade is used in a color laser printer to proportion toner powder evenly, and to maintain or eliminate the toner powder. The doctor blade includes a support rod and a blade part. The surface of the blade part has a surface covered with a protective layer. The blade part is secured to the support rod, and has blade tips that protrude from the blade part to proportion toner powder evenly. The protective layer can be of metals, such as gold, silver, zinc, aluminum, nickel or cadmium. With the use of the metal protective layer, the ability of the doctor blade to proportion toner powder evenly is greatly enhanced, raising print quality.

### BACKGROUND OF THE INVENTION

1. Field of the Invention

The present invention relates to a doctor blade, and in particular, to a doctor blade that is used in color laser printers for spreading toner evenly and maintaining a uniform negative charge level for the toner at the same time.

2. The Prior Arts

Generally, the workings of color laser printers is shown in FIG. 1, mainly comprising a charge roller 11, an organic photoconductive drum (OPC) 12 and a developing roller 13 for arranging print details and toner positioning.

The charge roller 11 discharges uniform negative charge, reverting the charge of the OPC 12 to initial setting. A pulsed laser light is used to reflect the to-be-printed image onto the fully charged OPC 12. The areas of the OPC reflected by the pulsed laser light creates different data positioning information, which is then memorized so that it is much like light exposure when charges are released. Within a toner cartridge, there is toner powder 15 and a developing roller 13, in which the Developing Roller 13 has also been charged, whereby the developing roller 13 can attract negatively charged toner powder. The developing roller 13 uses the released charge to bring the toner powder 15 away from the toner storage area, then the developing roller 13 come in contact with the OPC 12, which turns towards the same direction. Only the toner powder 15 that has a similar negative charge as the OPC 12 will be absorbed, similar to that of weak light exposure. The other areas that have not been exposed or have a different charge to the OPC reject each other, and therefore, no toner power 15 will be absorbed, leaving those areas blank. With the toner powder in formation according to the image information formed on the OPC 12, the toner powder can then be printed from the OPC 12 onto paper through high temperature compression, securing the toner powder on paper.

Before the developing roller 13 transfers the absorbed toner powder to the OPC 12, it needs to be processed by a doctor blade 14 so that the toner powder that passes through the developing roller 13 is proportioned, and the quality of the print will be even. The size of the toner powder used in common color laser printers are smaller than before. With smaller size toner powder and faster printing speed, it is even more important that the doctor blade 14 evenly proportions the toner powder and resists abrasion; therefore, the material of the doctor blade has been changed from elastic polyurethane (PU) to sheet metal. When large amounts of toner powder are used, and the metal doctor blade is working at a high speed, a collection of residual toner powder may occur. In order to improve the mishaps that occur from the use of polyurethane or pure metal doctor blade, an additional layer is needed to stop the collection of powder around the OPC due to static effects. Another traditional method in the way that the doctor blade and the developing roller come in contact, is to coat a polyurethane conductive layer on the metal to prevent oxidation; or glue a polyurethane conductive layer on the entire surface where the doctor blade and the developing roller come in contact. The polyurethane conductive layer is able to protect the surface of the metal doctor blade from oxidation, however, after prolonged use, the polyurethane conductive layer will easily fall off or abrasion will occur, lowering print quality. Also, the conductivity of the current material polyurethane is not as good as metal.

### SUMMARY OF THE INVENTION

To overcome the foregoing disadvantages, the present invention provides an abrasion-resistant and conductive doctor blade, made of strong but thin sheet metal that is able to evenly spread the toner powder. Using a flexible blade part, a layer of conductive metal cover is spread across the surface of the doctor blade, which resists abrasion and oxidation; the toner powder is also spread evenly and proportionally. At the same time, the present invention makes use of the conductivity of the doctor blade, to select toner powder that is similar in charge, achieving the most proportionate effect and improving the print quality.

The doctor blade of the present invention comprises a support rod and a blade part. The whole surface of the said blade part is made up of a blade body, which is wrapped up in a protective layer, and where the said blade part is connected to the support rod, a blade tip protrudes out to evenly proportion the toner powder. The blade body of the blade part is made up of flexible sheet metal. The protective layer can be made from metal, such as gold (Au), silver (Ag), zinc (Zn), aluminum (Al), nickel (Ni) and/or cadmium (Cd). The metallic protective layer serves to increase the hardness of the blade part. There will be no collection of toner powder on the sheet metal, allowing toner powder to be more evenly spread. Then the said blade part is secured onto the support rod, where a protrusion of a blade tip will be used to evenly spread toner powder. The doctor blade is charged by a conductivity connection hole on the blade part; the conductivity connection hole then facilitates the transmission of charges. Wherein the blade part of the present invention has been covered with the protective layer, the two layers becomes one, therefore, the said protective layer will not come apart. Due to its metallic material, not only will the protective layer prevent the metallic blade body from oxidation, its abrasion-resistant ability is better than polyurethane. At the same time, stronger charge from the blade part will assist in the correct identification of toner powder that's of opposite charge.

For more detailed information regarding the methods and features of the present invention, detailed descriptions will be provided in the preferred embodiment below, with references to the accompanying drawings.

### BRIEF DESCRIPTION OF THE DRAWINGS

FIG. 1 is a side elevation view schematically showing internal structure of a laser toner cartridge according to the present invention.

FIG. 2 is a perspective view of a doctor blade constructed in accordance with the present invention.

FIG. 3 is a side elevation view of the doctor blade.

### DETAILED DESCRIPTION OF THE PREFERRED EMBODIMENTS

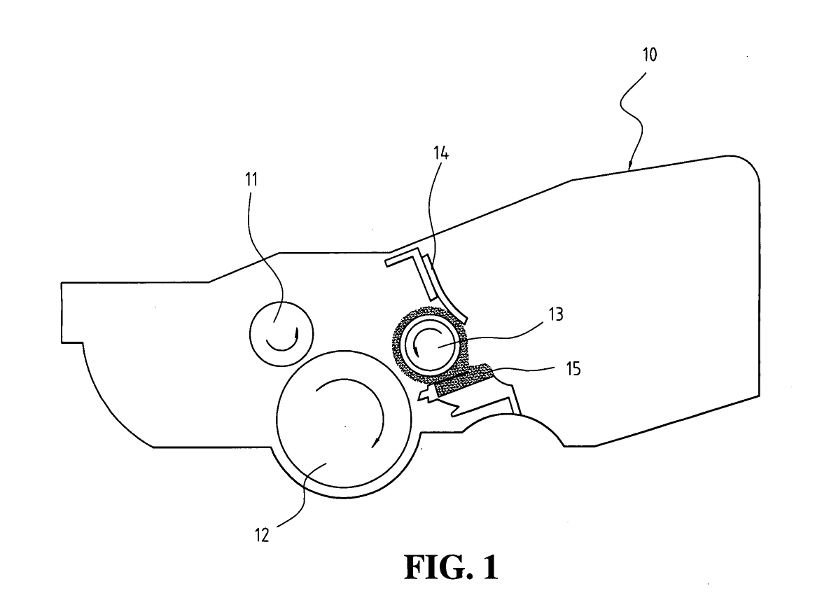

With reference to the drawings, and in particular to FIG. 1, a toner cartridge comprises a developing roller 13 on which toner powder is attached. The toner powder is first processed by a doctor blade 14, proportioning toner powder evenly on a developing roller 13. When the toner powder is to be absorbed into the developing roller 13, the absorption is done evenly due to the previous process of the doctor blade proportioning the toner powder. For the developing roller 13 to attraction and absorption the toner powder, both must be negatively charged, which is not always the case. Therefore, the doctor blade 14 absorbs positively charged toner powder, leaving only the negatively charged toner powder on the developing roller 13. The elimination of positively charged toner powder at the developing roller 14 prevents unwanted background dots. Therefore, the blade part 142 of the doctor blade 14 in this invention needs very strong conductivity for applying and sorting the charges, whereas the supporting rod 141 does not. So the said support rod 141 can be made from common aluminum, steel, stainless steel or any other material of sufficient hardness that achieves the goal of support; the material for the blade part 142 needs to have strong conductivity.

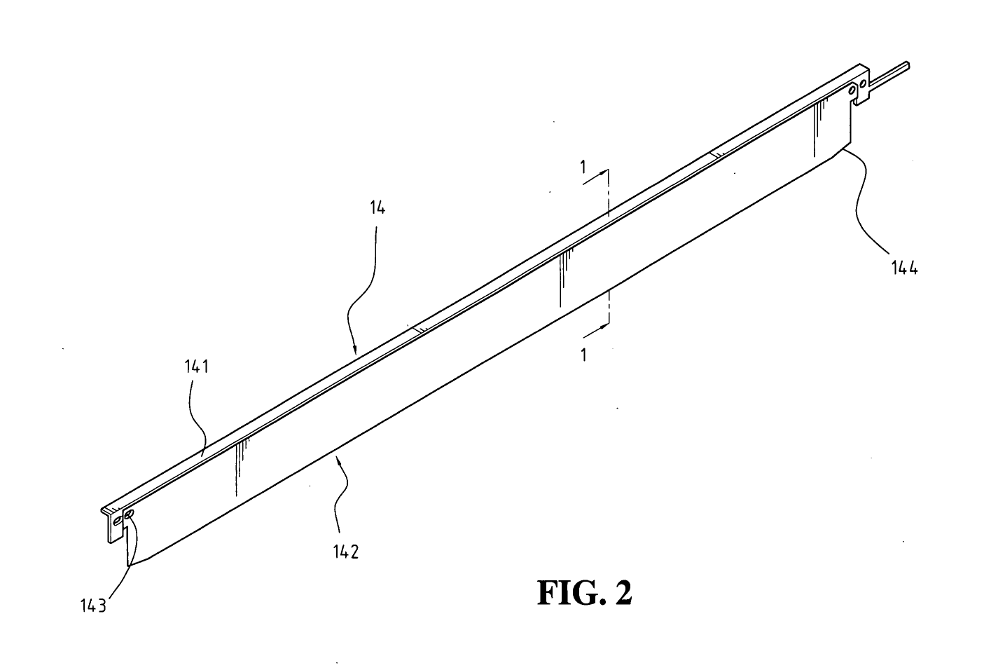

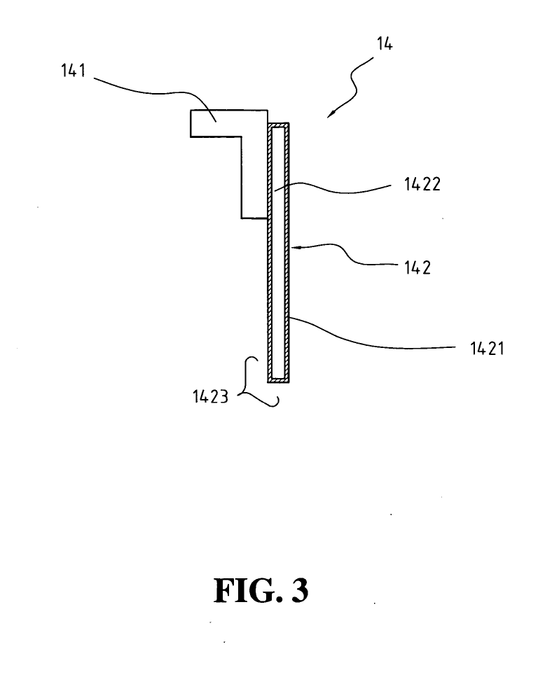

FIGS. 2 and 3 shows the doctor blade 14 of the present invention, where the material of the blade part 142 can be commonly used copper with good conductivity, or stainless steel with slightly worse conductivity; but the thickness of the metal must be flexible and bendable. The surface of blade part 142 must first be processed, by methods such as plating or electroless; the surface of blade body 1422 needs to be covered with an even layer of metal protective layer 1421, so strong conductivity is maintained; different to the prior arts, which used polyurethane that becomes detached after frequent or prolonged use, and had weak conductivity. Wherein the protective layer 1421 of the blade part 142 is significant in the prevention against oxidation, therefore, the metal's stability, oxidation resistance, abrasion resistance, conductivity and the metal's hardness are characteristics when selecting a metal for the protective layer 1421. The metals with such characteristics are gold (Au), silver (Ag), zinc (Zn), aluminum (Al), nickel (Ni), cadmium (Cd), or any combination with special characteristics. A conductive connection hole 143 on the blade part 142 maintains conductivity between the different parts, and has certain conductivity itself.

After the blade part 142 has been covered by the metal protective layer 1421, when secured, a blade tip 1423 will protrude from the blade part 142, which is used to contact the developing roller 13. At the point of contact, the blade part 142 is slightly curved and touching the surface of the developing roller (FIG. 1). The top of the developing roller 13 passes the toner power 15 of the doctor blade 14, so that the toner powder is proportioned evenly, and has a uniform negative charge.

When using the blade part 142 of the doctor blade 142, both sides of the blade tips 1423 will often push toner powder onto the side edges of the developing roller 13, causing spill out of toner powder. With the two corners of the blade tips 1423 are in the shape of up-ended triangles 144, when using the blade part 142, both sides of the blade tips 1423 are out of the paper-print boundary, not affecting print quality as the toner powder is still able to be proportioned evenly. However, due to the blade tips being in up-ended position, contact with both sides of the developing roller 13 is avoided, and therefore, can prevent mishaps such as toner spill out and abrasion of the developing roller 13.

What is claimed is:

1. A doctor blade adapted to be arranged in a toner cartridge, comprising a support rod and blade part, the blade part comprising a body, the surface of the body covered by a protective layer structure, the blade part secured to the secure rod, and a blade tip protruding from the blade part.

2. The doctor blade according to claim 1, wherein the protective layer is formed with metal.

3. The doctor blade according to claim 1, wherein conductivity connection hole on the blade part is used to enhance conductivity, with negative charge flowing from the doctor blade through to other areas of toner cartridge.

4. The doctor blade according to claim 1, wherein shape of the blade tip on both sides of the doctor blade is of an up-ended triangle.
